(19) United States
(12) Patent Application Publication
(10) Pub. No.: US 2006/0165481 A1
(43) Pub. Date: Jul. 27, 2006

(54) Coupling element for inverted t beams

(76) Inventor: Mauro Barbuio, Gruaro (IT)

Correspondence Address: Hoffman Wasson & Gitler, 2461 South Clark Street, Suite 522 Crystal Center II, Arlington, VA, 22202, US

(21) Appl. No.: 10/531,909

(22) PCT Filed: Nov. 5, 2003
(86) PCT No.: PCT/EP03/12339

§ 371 Date: Apr. 19, 2005

(30) Foreign Application Priority Data
Nov. 8, 2002 (IT) VE2002U000027

(51) Int. Cl. E06B 3/99

(52) U.S. Cl. 403/346

(57) ABSTRACT

An improved coupling element for inverted T beams characterised by comprising at their ends an appendix (2) formed from two portions (8, 10) of different height, the outer portion (10) having the lesser height and being bent to V-shape with the free part (14) comprising a tooth (16), and in their central web (4) at least one aperture (18) having a height substantially corresponding to the height of the outer portion (10), for the insertion of said portion and its stable retention by the tooth and by the edge of the inner portion (8).

The present invention relates to an improved coupling element for inverted T beams.

Structural elements for false ceilings are known consisting of beams of inverted T cross-section provided at their ends with hooks, which are either formed directly on the central web of the T beam or are in the form of inserts which are constructed separately and applied to each beam section during its construction.

Said beams are also provided in their web with cut-outs in which to engage the coupling element of a beam perpendicular to it, to form a lattice structure which is generally suspended from the ceiling, usually by steel cables or tie bars, to functionally support with its horizontal flanges those panels and staves or the like necessary to form the false ceiling.

A known type of beam comprises an element which is subjected to pressing to form an elastic strip in which, by cutting and plastic deformation, at least one tooth is defined having its abutment surface facing the beam, to form an insertion connection with the cut-out provided in the web of the beam.

A drawback of this coupling element is a certain laboriousness both in constructing the strip and in disengaging the strip from the cut-out in which it is engaged.

An object of the invention is to provide an improved coupling element which enables the appendix to be easily and quickly engaged with and disengaged from the cut-out.

This and further objects which will be apparent from the ensuing description are attained according to the invention by an improved coupling element for inverted T beams as claimed in claim 1.

The present invention is described in detail hereinafter with reference to the accompanying drawings, in which:

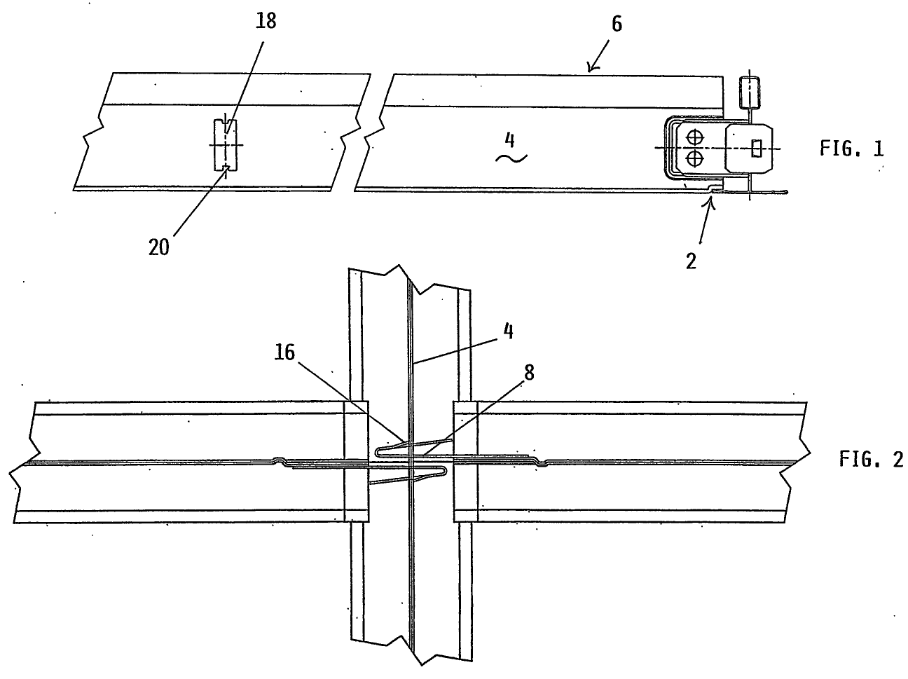

FIG. 1 is a side view of a beam provided with the coupling element of the invention;

FIG. 2 is a plan view of a coupling element inserted into the central web;

FIG. 3 is an enlarged view of the coupling appendix;

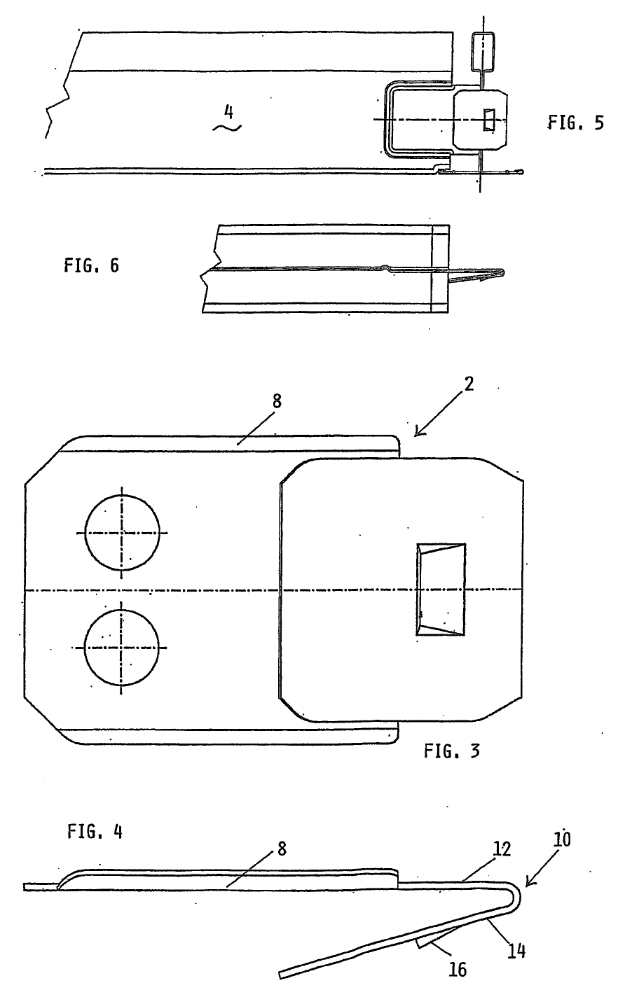

FIG. 4 is a side view thereof;

FIG. 5 is a side view of a beam with the appendix formed in one piece therewith; and

FIG. 6 is a plan view thereof.

As can be seen from the figures, the improved coupling element 2 of the invention is applied to the ends of the central web 4 of a beam of inverted T cross-section, said element being formed separately and applied to each beam part during its construction.

The coupling element comprises a substantially rectangular first portion 8 applied by traditional riveting to the ends of the central web, the portion 8 extending into a second portion 10 of lesser height which is bent substantially to V-shape with a portion 12 coplanar with the first portion 8 and with a second portion 14 comprising a tooth 16 obtained by cutting and plastic deformation, the free end of the tooth substantially facing the end of the first portion 8.

The central web 4 comprises a substantially rectangular cut-out 17 with its minor side provided with a projection 20 and with its major side having a length substantially corresponding to that of the second portion 10 of the coupling element.

In this manner the projection 20 defines two apertures 18 each suitable for engagement by the opposing part of the coupling elements.

To assemble the lattice structure, the operator inserts the V-bent element 8 of the coupling element 2 into the aperture 18 of the central web 4, so compressing together the two parts 12, 14 of the second portion 10 until the free end of the tooth 16 becomes positioned on the other side of the web, to hence retain it with the end of the first portion 8 (see FIG. 2).

When it becomes necessary to mutually disengage the beams, the operator presses the free end 14 of the V portion 10 so as to disengage the undercut formed by the tooth 16 from the edge of the aperture 18 and then axially withdraws the coupling element therefrom.

In the embodiment shown in FIGS. 5 and 6 the coupling element is obtained directly during the beam construction.

From the aforegoing it is clear that the improved coupling element according to the invention presents the advantage not only of constructional simplicity, but also of a greater ease of release by virtue of the better accessibility of the appendix part to be pressed, without having to perform unusual manoeuvres.

1. (canceled)

2. An element as claimed in claim 4 wherein the appendix is secured to the ends of the beam by riveting.

3. An element as claimed in claim 4 wherein the appendix is formed in one piece with the beam.

4. An inverted T-beam comprising:
two ends and a central web;
at least one of its ends having an appendix formed from two portions of a different height, a first inner portion extending into a second outer portion, said outer portion having the lesser height and being bent to a V-shape comprising two parts forming the two legs of said V-shape, a first part being coplanar with the first portion and the second free part comprising a tooth obtained by cutting out and plastically deforming a part of the second part, the free end of the tooth substantially facing the end of the first portion, and
at least one aperture in the central web having a height substantially corresponeding to the height of said outer portion of the appendix such that said aperture is suitable for the insertion and for the stable retention of the outer portion of the appendix of another inverted T-beam having an identical appendix by the tooth and the edge of the inner portion of said other inverted T-beam.
